(19) United States
(12) Patent Application Publication
(10) Pub. No.: US 2010/0095372 A1
(43) Pub. Date: Apr. 15, 2010

(54) TRUSTED RELYING PARTY PROXY FOR INFORMATION CARD TOKENS

(75) Inventors: Andrew A. Hodgkinson, Pleasant Grove, UT (US); James M. Norman, Pleasant Grove, UT (US); Daniel S. Sanders, Orem, UT (US)

Correspondence Address: MARGER JOHNSON & MCCOLLOM, P.C. - NOVELL, 210 SW MORRISON STREET, SUITE 400, PORTLAND, OR, 97204, US

(73) Assignee: NOVELL, INC., Provo, UT (US)

(21) Appl. No.: 12/248,815

(22) Filed: Oct. 9, 2008

(51) Int. Cl. H04L 9/32; G06F 17/30

(52) U.S. Cl. 726/20; 726/19; 707/E17.014

(57) ABSTRACT

An apparatus can include a secret mapping module running on a machine and configured to create a mapping that maps a secret to a claim stored in an information card, a receiver running on the machine and configured to receive a request for the secret from a remote application, a mapping query module running on the machine and configured to perform a search for the mapping, a credential provider application running on the machine and configured to retrieve the secret based at least in part on the claim, and a transmitter configured to transmit the secret to the remote application.

### CROSS-REFERENCE TO RELATED APPLICATIONS

This application is related to co-pending and commonly owned U.S. patent application Ser. No. 11/843,572, titled “PERFORMING A BUSINESS TRANSACTION WITHOUT DISCLOSING SENSITIVE IDENTITY INFORMATION TO A RELYING PARTY,” U.S. patent application Ser. No. 11/843,638, titled “POLICY-BASED AUDITING OF IDENTITY CREDENTIAL DISCLOSURE BY A SECURE TOKEN SERVICE,” U.S. patent application Ser. No. 11/843,640, titled “FRAMEWORK AND TECHNOLOGY TO ENABLE THE PORTABILITY OF INFORMATION CARDS,” U.S. patent application Ser. No. 11/843,608, titled “CHAINING INFORMATION CARD SELECTORS,” and U.S. patent application Ser. No. 11/843,591, titled “CREDENTIAL CATEGORIZATION,” all of which were filed on Aug. 22, 2007, and all of which claim the benefit of U.S. Provisional Patent Application Ser. Nos. 60/895,312, 60/895,316, and 60/895,325, which were filed on Mar. 16, 2007. All of the foregoing applications are fully incorporated by reference herein.

This application is also related to co-pending and commonly owned U.S. patent application Ser. No. 12/019,104, titled “PROCESSING HTML EXTENSIONS TO ENABLE SUPPORT OF INFORMATION CARDS BY A RELYING PARTY,” filed on Jan. 24, 2008, which claims the benefit of U.S. Provisional Patent Application Ser. No. 60/973,679, filed on Sep. 19, 2007; and is related to co-pending and commonly owned U.S. patent application Ser. No. 12/030,063, titled “INFO CARD SELECTOR RECEPTION OF IDENTITY PROVIDER BASED DATA PERTAINING TO INFO CARDS,” filed on Feb. 12, 2008; and is related to co-pending and commonly owned U.S. patent application Ser. No. 12/029,373, titled “VISUAL AND NON-VISUAL CUES FOR CONVEYING STATE OF INFORMATION CARDS, ELECTRONIC WALLETS, AND KEYRINGS,” filed on Feb. 11, 2008; and is related to co-pending and commonly owned U.S. patent application Ser. No. 12/054,774, titled “CLAIM CATEGORY HANDLING,” filed on Mar. 25, 2008; and is related to co-pending and commonly owned U.S. patent application Ser. No. 12/042,205, titled “PRIVATELY SHARING RELYING PARTY REPUTATION WITH INFORMATION CARD SELECTORS,” filed on Mar. 4, 2008; and is related to co-pending and commonly owned U.S. patent application Ser. No. 12/026,775, titled “METHODS FOR SETTING AND CHANGING THE USER CREDENTIAL IN INFORMATION CARDS,” filed on Feb. 6, 2008. All of the foregoing applications are fully incorporated by reference herein.

This application is also related to co-pending and commonly owned U.S. patent application Ser. No. 12/038,674, titled “SYSTEM AND METHOD FOR SECURE ACCOUNT RESET UTILIZING INFORMATION CARDS,” filed on Feb. 27, 2008; and is related to co-pending and commonly owned U.S. patent application Ser. No. 12/044,816, titled “SYSTEM AND METHOD FOR USING WORKFLOWS WITH INFORMATION CARDS,” filed on Mar. 7, 2008; and is related to co-pending and commonly owned U.S. patent application Ser. No. 12/108,805, titled “RESTRICTED USE INFORMATION CARDS,” filed on Apr. 24, 2008; and is related to co-pending and commonly owned U.S. patent application Ser. No. 12/112,772, titled “DYNAMIC INFORMATION CARD RENDERING,” filed on Apr. 30, 2008; and is related to co-pending and commonly owned U.S. patent application Ser. No. 12/054,137, titled “CARDSPACE HISTORY VALIDATOR,” filed on Mar. 24, 2008; and is related to co-pending and commonly owned U.S. patent application Ser. No. 12/111,874, titled “REMOTABLE INFORMATION CARDS,” filed on Apr. 29, 2008. All of the foregoing applications are fully incorporated by reference herein.

This application is also related to co-pending and commonly owned U.S. patent application Ser. No. 12/170,384, titled “NON-INTERACTIVE INFORMATION CARD TOKEN GENERATION,” filed on Jul. 9, 2008; and is related to co-pending and commonly owned U.S. patent application Ser. No. 12/184,155, titled “SITE-SPECIFIC CREDENTIAL GENERATION USING INFORMATION CARDS,” filed on Jul. 31, 2008; and is related to co-pending and commonly owned U.S. patent application Ser. No. 12/201,754, titled “SYSTEM AND METHOD FOR VIRTUAL INFORMATION CARDS,” filed on Aug. 29, 2008. All of the foregoing applications are fully incorporated by reference herein.

### TECHNICAL FIELD

The disclosed technology pertains to using information cards, and more particularly to the mapping of secrets such as credentials (e.g., username and password information) to claims within information cards.

### BACKGROUND

When a user interacts with sites on the Internet (hereafter referred to as “service providers” or “relying parties”), the service provider often expects to know something about the user that is requesting the services of the provider. The typical approach for a service provider is to require the user to log into or authenticate to the service provider's computer system. But this approach, while satisfactory for the service provider, is less than ideal for the user.

First, the user must remember a username and password for each service provider who expects such information. Given that different computer systems impose different requirements, and the possibility that another user might have chosen the same username, the user might be unable to use the same username/password combination on each such computer system. (There is also the related problem that if the user uses the same username/password combination on multiple computer systems, someone who hacks one such computer system would be able to access other such computer systems.)

It is estimated that an average user has over 100 accounts on the Internet. For users, this is becoming an increasingly frustrating problem to deal with. Passwords and account names are too hard to remember. Second, the user has no control over how the service provider uses the information it stores. If the service provider uses the stored information in a way the user does not want, the user has relatively little ability to prevent such abuse, and essentially no recourse after the fact.

In the past few years, the networking industry has developed the concept of information cards to tackle these problems. Information cards are a very familiar metaphor for users and the idea is gaining rapid momentum. Information cards allow users to manage their identity information and control how it is released. This gives users greater convenience in organizing their multiple personae, their preferences, and their relationships with vendors and identity providers. Interactions with on-line vendors are greatly simplified.

There are currently two kinds of information cards: personal cards (or self-issued cards) and managed cards (or cards that are issued by an identity provider). A personal card contains self-asserted identity information—the person issues the card and is the authority for the identity information it contains. The managed card is issued by an identity provider. The identity provider provides the identity information and asserts its validity.

When a user wants to release identity information to a relying party (for example, a web site that the user is interacting with), a tool known as a card selector assists the user in selecting an appropriate information card. When a managed card is selected, the card selector can communicate with the identity provider to obtain a security token that contains the needed information.

While information card technologies are becoming more widespread in applications, there remain problems with certain scenarios. Currently, when a user attempts to access a legacy application using single sign-on (SSO) technologies (such as GroupWise, for example), the legacy application typically requires certain login information and thus prompts the user for an appropriate username and password combination. The user is thus burdened with a need to not only recall the particular username and password combination for the legacy application but also to manually enter the information. This process can be time-consuming and distracting.

A need remains for a way to address these and other problems associated with the prior art.

### SUMMARY

Embodiments of the disclosed technology can desirably extend advantageous features of information card technologies to systems such as legacy systems that rely on single sign-on (SSO) technologies. For example, a relying party (e.g., a legacy application) can request a credential (e.g., a username and a password). A credential provider application (e.g., a CardSpace client) can query the user's information cards for a card having a claim (e.g., having a claim identifier that is a URI), wherein the credential is mapped to the claim. Once the claim has been identified, the credential provider application can retrieve (e.g., from an identity provider) the requested credential based on the claim. The credential can then be transmitted to the relying party.

In certain embodiments of the disclosed technology, an information card selector can be used to prompt a user select an information card (e.g., storing the pertinent claim). The card selector can present all of the user's information cards for selection. In alternative embodiments, the only information cards to be presented to the user are information cards identified as storing the pertinent claim.

In certain embodiments of the disclosed technology, a secret store provider can be implemented to search a local secret store for the requested credential. The secret store provider can be used if no information card having the pertinent claim is found, for example. Alternatively, the secret store provider can be used first and, if the requested credential is not located in the local secret store, a credential provider application can then be used to query the information cards for the pertinent claim.

In situations where the requested credential cannot be located, or if there is an error during processing, for example, the credential provider application can default to allowing the legacy application to directly contact the user (e.g., by prompting the user with a login form requesting the credential).

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a sequence of communications between a client, a relying party, and an identity provider.

FIG. 2 shows details of the computer system of FIG. 1, such as a card selector, a receiver, a transmitter, and a browser.

FIG. 3 shows an example of an information card that includes a claim consisting of a claim type and a claim identifier.

FIG. 4 shows an example sequence of communications between a credential provider application and a legacy application in accordance with certain implementations of the disclosed technology.

FIG. 5 shows a flowchart of an example procedure for returning a secret such as a credential in response to a request issued by a legacy application.

FIG. 6 shows a flowchart of an alternative procedure for returning a requested secret such as a credential to a legacy application.

FIGS. 7A-7B show a flowchart of a more detailed example procedure for sending a secret to a legacy application in response to a request for the secret.

FIGS. 8A-8B show a flowchart of an alternative implementation of a procedure for returning a requested secret to a legacy application.

### DETAILED DESCRIPTION

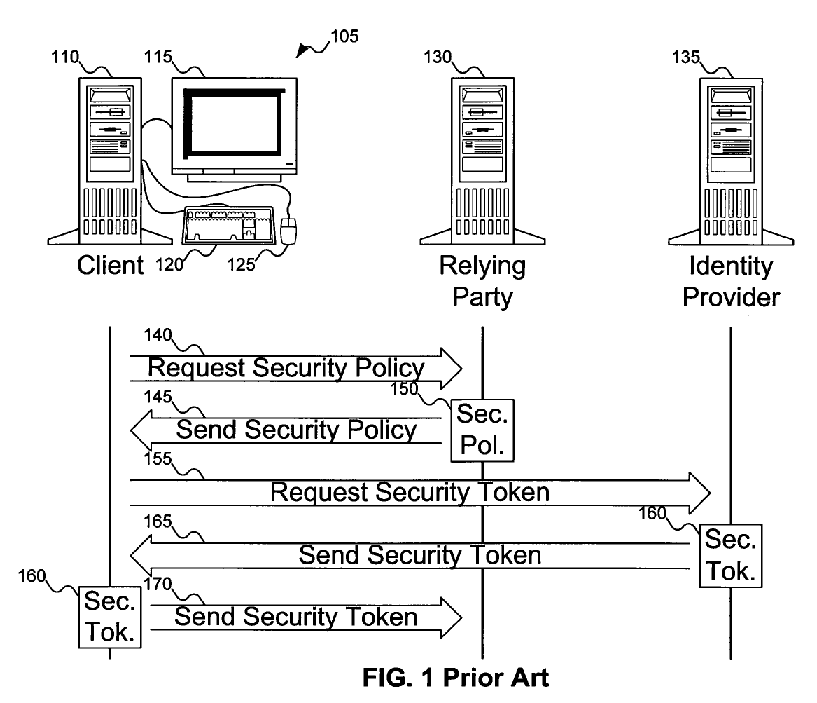

Before describing various embodiments of the disclosed technology, it is important to understand the context of the disclosed technology. FIG. 1 shows an example of a sequence of communications between a client, a relying party, and an identity provider. For simplicity, each of the parties (the client, the relying party, and the identity provider) may be referred to by their respective machines. Actions attributed to each party are taken by that particular party's machine, except where the context indicates that the actions are taken by the actual party itself.

In FIG. 1, a computer system 105 (the client) is shown as including a computer 110, a monitor 115, a keyboard 120, and a mouse 125. A person skilled in the art will recognize that other components can be included with the computer system 105, such as other input/output devices (e.g., a printer), for example. In addition, FIG. 1 does not show some of the conventional internal components of the computer system 105, such as a central processing unit, memory, storage, etc. Although not shown in FIG. 1, a person skilled in the art will recognize that the computer system 105 can interact with other computer systems, such as a relying party 130 and an identity provider 135, either directly or over a network (not shown) of any type. Finally, although FIG. 1 shows the computer system 105 as a conventional desktop computer, a person skilled in the art will recognize that the computer system 105 can be any type of machine or computing device capable of providing the services attributed herein to the computer system 105, including, for example, a laptop computer, a personal digital assistant (PDA), or a cellular telephone.

The relying party 130 is typically a machine managed by a party that relies in some way on the identity of the user of the computer system 105. The operator of the relying party 130 can generally be any type of relying party. For example, the operator of the relying party 130 can be a merchant running a business on a website. Alternatively, the operator of the relying party 130 can be an entity that offers assistance on some matter to registered parties. The relying party 130 is so named because it relies on establishing some identifying information about the user. For purposes of the present application, the relying party 130 can refer to an application (e.g., a legacy application) residing on and/or running on the computer system 105 itself.

The identity provider 135 is typically managed by a party that is responsible for providing identity information (or other such information) about the user for consumption by the relying party 130. Depending on the type of information that the identity provider 135 stores for a user, a single user might store identifying information with any number of different identity providers 135, any of which might be able to satisfy the request of the relying party 130. For example, the identity provider 135 might be a governmental agency responsible for storing information generated by the government, such as a driver's license number or a social security number. Alternatively, the identity provider 135 might be a third party that is in the business of managing identity information on behalf of a wide variety of users.

Conventional methodology of releasing identity information can be found in a number of sources, such as a document published by Microsoft entitled “Introducing Windows CardSpace,” which can be found on the World Wide Web at http://msdn2.microsoft.com/en-us/library/aa480189.aspx and is hereby incorporated by reference. To summarize the operation of Windows CardSpace, when a user wants to access some data from the relying party 130, the computer system 105 requests the security policy of the relying party 130, as shown in a communication 140, which is returned in a communication 145 as a security policy 150. The security policy 150 is typically a summary of the information the relying party 130 needs, how the information should be formatted, and so on.

Once the computer system 105 has the security policy 150, the computer system 105 can identify which information cards will satisfy the security policy 150. Different security policies might result in different information cards being usable. For example, if the relying party 130 simply needs a username and password combination, the information cards that will satisfy this security policy will typically be different from the information cards that satisfy a security policy requesting the user's full name, mailing address, and social security number. The user can then select an information card that satisfies the security policy 150.

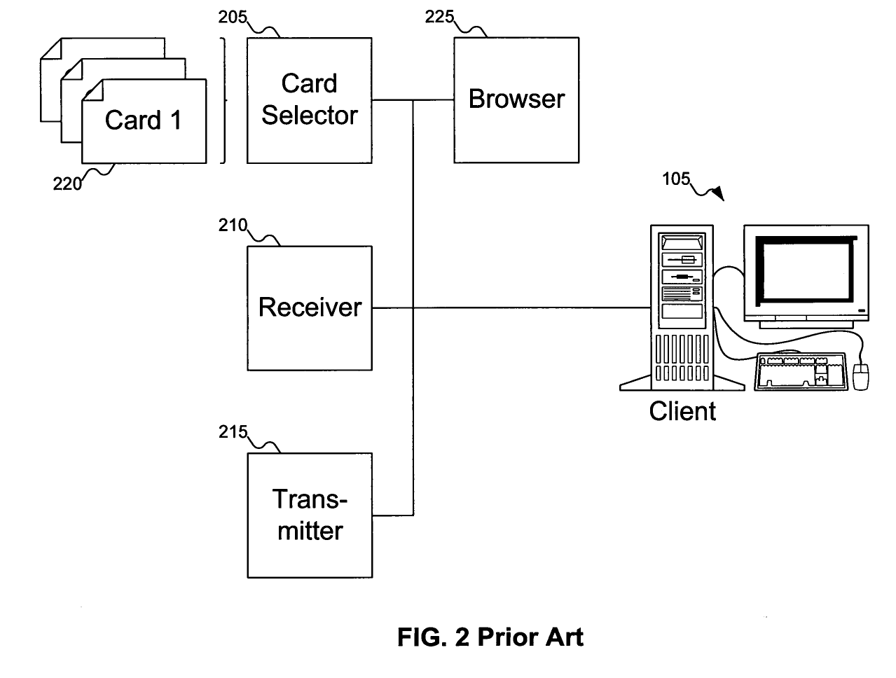

A card selector (described below with respect to FIG. 2) on the computer system 105 can be used by the user to select the appropriate information card. The card selector may present the user with a list or graphical display of all available information cards. Information cards that satisfy the security policy may be highlighted in some way to distinguish them from the remaining cards. Alternatively, the card selector may display only the information cards that will satisfy the security policy. The card selector may provide a means for the user to select the desired information card by, for instance, a mouse click or a touch on a touch screen.

Once the user has selected an acceptable information card, the computer system 105 can use the selected information card to transmit a request for a security token from the identity provider 135, as shown in a communication 155. This request can identify the data to be included in the security token, the credential that identifies the user, and other data the identity provider needs to generate the security token. The identity provider 135 can return a security token 160, as shown in a communication 165. The security token 160 can include a number of claims (e.g., pieces of information) that typically include data that the user wants to release to the relying party. The security token 160 is usually encrypted in some manner, and perhaps signed and/or time-stamped by the identity provider 135 so that the relying party 130 can be certain that the security token originated with the identity provider 135, as opposed to being spoofed by someone intent on defrauding the relying party 130. The computer system 105 can then forward the security token 160 to the relying party 130, as shown in a communication 170.

In addition, the selected information card can be a self-issued information card (also called a personal card): that is, an information card issued not by an identity provider, but by the computer system 105 itself. In that case, the identity provider 135 effectively becomes part of the computer system 105.

In this model, a person skilled in the art will recognize that because all information flows through the computer system 105, the user has a measure of control over the release of the user's identity information. The relying party 130 only receives the information the user wants the relying party 130 to have, and does not store that information on behalf of the user (although it would be possible for relying party 130 to store the information in the security token 160: there is no effective way to prevent such an act).

FIG. 2 shows details of the computer system of FIG. 1. Referring to FIG. 2, the computer system 105 includes a card selector 205, a receiver 210, a transmitter 215, and a browser 225. The card selector 205 is typically responsible for enabling a user to select an information card 220 that satisfies the security policy (e.g., as described above with respect to FIG. 1). The card selector 205 is also typically responsible for enabling a user to obtain managed cards from identity providers and to install the managed cards on the computer system 105. The receiver 210 is generally responsible for receiving data transmitted to the computer system 105, while the transmitter 215 is usually responsible for transmitting information from the computer system 105. The receiver 210 and the transmitter 215 may facilitate communications between, for example, the computer system 105, the relying party 130, and the identity provider 135. The browser 225 can allow the user to interact with web pages on a network, such as web pages created by the identity provider 135. The user may use the browser 225 to obtain a managed card by, for example, visiting a web page created by the identity provider 135 and filling out a web-based form.

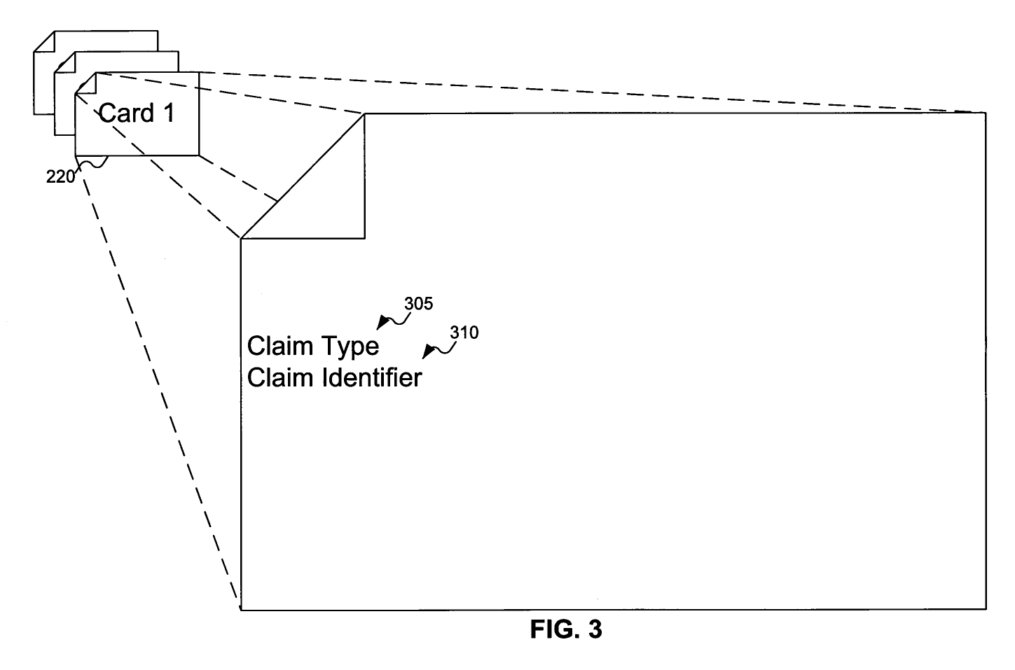

An example of an information card is illustrated in FIG. 3, which shows the information card 220 of FIG. 2 in greater detail. The information card 220 includes a particular data element known as a claim, which consists of a claim type 305 and a claim identifier 310. The claim type 305 can be one of a wide variety of available claim types such as user name, mailing address, email address, date of birth, gender, or a private personal identifier, for example. In certain embodiments of the disclosed technology, the claim type 305 is a web page, in which case the claim identifier 310 would typically include a Uniform Resource Identifier or URI (e.g., a web page expressed as a Uniform Resource Locator or URL). The claim identifier 310 is typically information (e.g., a specific value) according to the value of the claim type 305.

Where the information card 220 is a managed information card (that is, managed by an identity provider 135), the information represented by the information card 220 is not actually stored on the user's computer. This information is stored by the identity provider 135. Thus, the information displayed on the information card 220 would not be the actual information stored by the computer system 105, but rather an indicator of what information is included in the information card 220.

Legacy applications that use single sign-on (SSO) technologies typically store credential information in credential vaults associated with services and applications such as the Common Authentication Service Adapter (CASA), Secret Store, GNOME Keyring, KDE Wallet, Firefox Password Manager, etc. Because each application (and associated credential vault) is unique, applications are generally written to specific application programing interfaces (APIs).

Embodiments of the disclosed technology can extend the advantageous features of information card technologies to native (e.g., non-web-based) applications such as legacy applications using SSO technologies by, for example, by providing a user (e.g., an administrator) with the ability to map secrets (e.g., keys used to store credential metadata) to claims that are supported in information cards. Embodiments of the disclosed technology can thus extend identity providers to support encrypted credential storage and one-time use credentials in support of SSO via information cards.

Embodiments of the disclosed technology can also enforce policies that are related to the disclosure of credentials as well as any associated auditing, thereby improving system security by providing additional control as to when and what credentials are provided to native (e.g., non-web-based) applications.

In certain implementations of the disclosed technology, CASA APIs can be used to provide an ability to query a CASA secret store for information card credentials that are mapped. For example, a CASA engine can query the CASA secret store for mapping metadata (e.g., configured by the user). Consider an example involving the following URI:
http://schemas.xmlsoap.orz/ws/2005/05/identity/claims/givenname
   In the example, a GroupWise application requests a CN key, which is mapped to the . . . /givenname claim, and a Password key, which is mapped to the . . . /webpage claim.

Embodiments of the disclosed technology can include a search for an information card mapping (e.g., in a claim stored in the selected information card). If an information card mapping is found, an identity selector (e.g., DigitalMe) can be invoked to request a “simple” (e.g., unencrypted) claim set using the claim (e.g., claim identifier) found in the mapping metadata. If no mapping is found, however, the CASA engine can automatically query its local store to look for the credential values that are being requested.

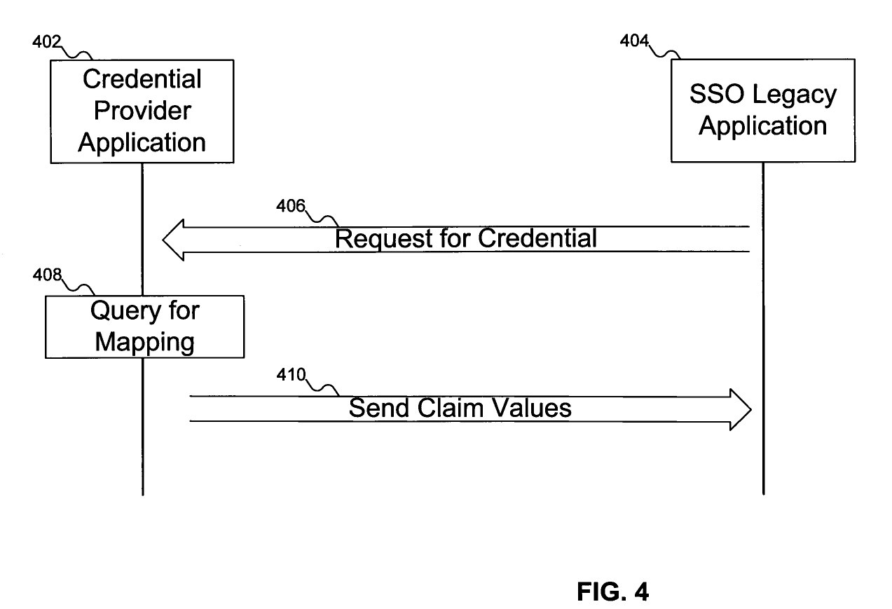

FIG. 4 shows an example sequence of communications between a credential provider application 402 and a SSO legacy application 404 (e.g., a GroupWise application) that requires a credential such as a username and a password combination, for example. The SSO legacy application 404 typically stores credentials in a credential store such as a CASA secret store. In the example, a user interacts with a SSO legacy application 404 (e.g., by accessing an email account).

The SSO legacy application 404 first requests a credential (e.g., keys) from a credential provider (not shown). In the example, a credential is not found, so the SSO legacy application 404 sends a request for a credential 406 to the credential provider application 402.

The credential provider application 402 triggers a query 408 for a mapping of credential keys to a claim within one or more of the user's information cards. Once a claim has been identified in at least one information card, the credential provider application 402 can then use the claim in the information card to retrieve a token. The credential provider application 402 can then send the associated claim values to the SSO legacy application 404, as shown in a communication 410.

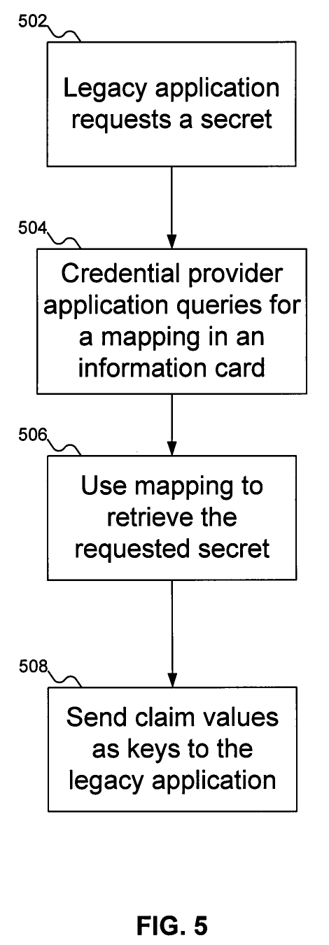

FIG. 5 shows a flowchart of an example procedure for returning a secret (e.g., a credential) in response to a request issued by a legacy application (e.g., a GroupWise application). At 502, a legacy application (e.g., a SSO legacy application) prompts a user for a secret such as a credential (e.g., a username and password combination). For example, the user might be trying to access his or her email account within the legacy application.

At 504, the credential provider application invokes a query operation (e.g., on the user's machine) to search for the requested secret. For example, the credential provider application can search for a mapping of the requested secret to a claim contained within one or more of the user's information cards.

At 506, a mapping (e.g., between the secret and the claim) is found and the credential provider application uses the mapping to retrieve the requested secret.

At 508, the credential provider application passes the claim values as keys for the credential requested by the legacy application. In the example, the credential provider application is essentially acting as a credential provider and the legacy application is essentially acting as a relying party even though both applications may reside on the same machine.

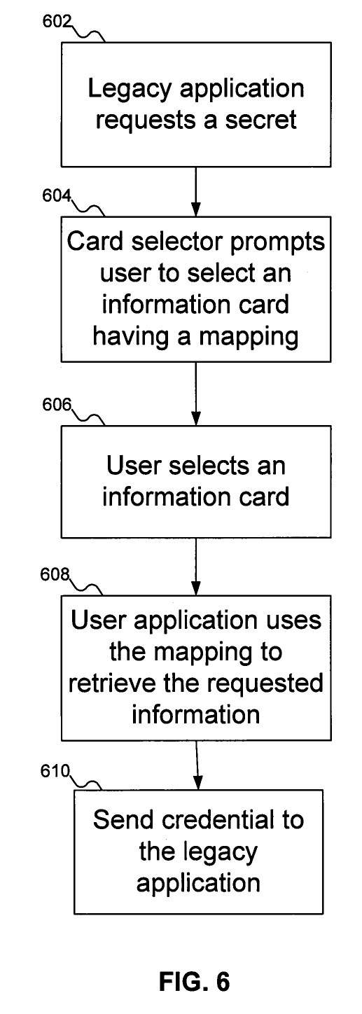

FIG. 6 shows a flowchart of an alternative procedure for returning a requested secret (e.g., credential) to a legacy application. At 602, a legacy application prompts a user (directly or indirectly) for a secret such as a credential (e.g., username and password). For example, the user might be attempting to access an email account associated with the legacy application.

At 604, the credential provider application triggers a card selector to prompt the user to select a particular information card. For example, the credential provider application can provide the user with a listing of one or more information cards that each include a particular mapping to an information card claim. In certain embodiments, the card selector can present the user with all available information cards. In other embodiments, the card selector can perform a search such that it only presents to the user information cards containing a mapping of the requested information. Thus, rather than prompt the user for a username/password combination, the credential provider application advantageously presents an information card (or a wallet fall of information cards) to the user in order to allow the user to select a particular information card (or cards) to the legacy application for authentication purposes, for example.

At 606, the user selects an information card.

At 608, the credential provider application uses the mapping of the claim in the information card to retrieve the requested information. In alternative embodiments, the credential provider application can select a particular information card without prompting the user. For example, if there is only one information card having a mapping corresponding to the request, the credential provider application can automatically select this card without prompting the user.

At 610, the credential provider application passes the requested information to the legacy application. Thus, when the legacy application requests a certain password, for example, the credential provider application (e.g., acting as a credential provider) can be configured to first determine that the requested password is mapped to a particular claim stored within an information card, trigger a card selector client to prompt the user to select the information card to provide the value for the password, and return the value of the password to the legacy application in response to the request.

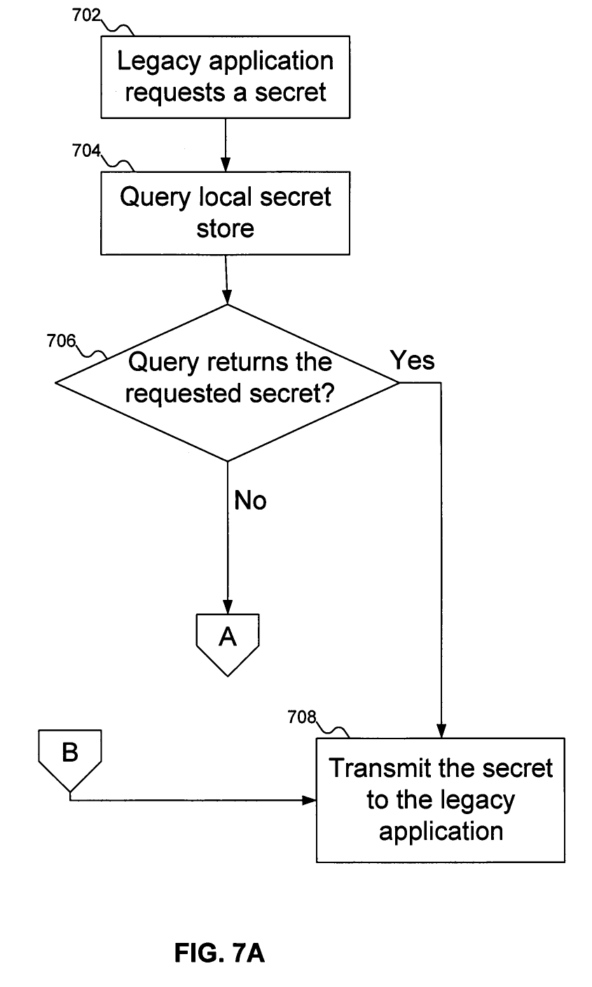

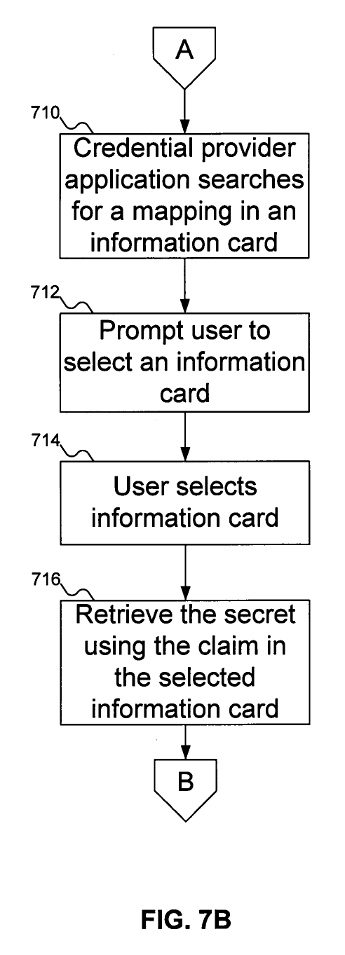

FIGS. 7A-7B show a flowchart of a more detailed example procedure for returning a requested secret (e.g., a credential) to a legacy application. At 702 in FIG. 7A, a legacy application requests a secret such as a credential (e.g., a username/password combination) from the user. A credential provider application can be set to notify the user of the request. Alternatively, the credential provider application can be set to handle such requests with little to no direct interaction with the user.

At 704, a query is performed on a local secret store. In the example, the local secret store provider is located on the user's machine. For example, a GroupWise application requesting a CN key can query a CASA secret store for a secret having an ID “GroupWise” and related keys “CN” and “Password.”

At 706, a determination is made (e.g., based on certain preconfiguration parameters) as to whether the requested secret is cached locally (e.g., within the secret store on the user's machine). If the determination is that the secret is indeed stored locally, the secret can then be sent to the legacy application, as shown at 708. Otherwise processing can continue to 710, as shown in FIG. 7B.

At 710, the credential provider application searches the user's information cards for a mapping for the requested secret to a claim within the information card (or cards). The credential provider application effectively acts as a secret store provider by using the mapping to provide the requested secret to the legacy application via a CASA API, for example. One of the various advantageous features of such an implementation is that, whereas legacy applications typically cannot communicate directly to a CardSpace client application, such legacy applications can generally communicate with CASA (e.g., using a CASA API).

At 712, the credential provider application invokes a card selector to prompt the user to select a particular information card. In certain embodiments, the card selector can be invoked in response to the presence of a claim having a claim identifier that is a URI. The card selector can present all of the user's information cards to the user. Alternatively, the card selector can be set to limit the cards presented to the user. For example, the card selector can limit the cards presented to the user to cards that have the pertinent mapping or mappings. If no such information card is found, however, or if there is an error during processing, the user can be prompted directly for the secret (e.g., via a login form for the legacy application).

At 714, the user selects an information card. In alternative embodiments, the credential provider application can be programmed to select an information card without prompting the user. For example, the credential provider application can be set to automatically select an information card based on certain paramaters (e.g., in situations where only one information card is identified as having the pertinent mapping).

At 716, the secret is retrieved using the pertinent claim in the selected information card. Once the secret is retrieved, it can be sent to the legacy application, as shown at 708.

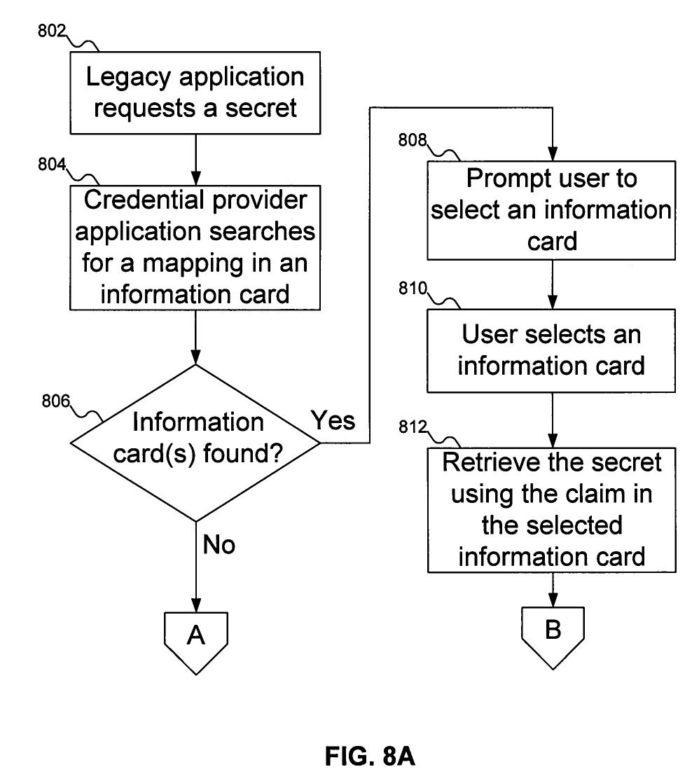

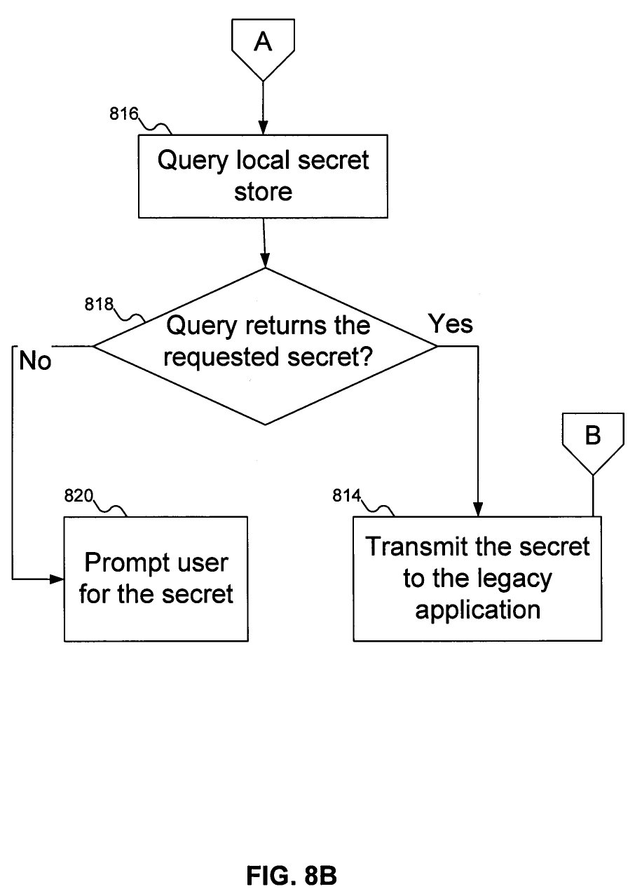

FIGS. 8A-8B show a flowchart of an alternative implementation of a procedure for returning a requested secret (e.g., a credential) to a legacy application. At 802 in FIG. 8A, a legacy application requests a secret such as a credential (e.g., a username/password combination) from the user via a CardSpace client application (such as DigitalMe, for example).

At 804, a credential provider application searches the user's information cards for a mapping for the requested secret to a claim within the information card (or cards). At 806, a determination is made as to whether an information card having the pertinent mapping is found. If at least one information card having the pertinent mapping is found, the procedure continues at 808. If no information cards are found, however, the procedure continues to 816 in FIG. 8B

At 808, the credential provider application prompts the user to select a particular information card. The user then selects the information card at 810. At 812, the secret can be retrieved using the pertinent claim in the selected information card (e.g., as described above) and, once the secret has been retrieved, it can be transmitted to the legacy application, as shown at 814 in FIG. 8B.

At 816, a query is performed on a local secret store and a determination is made as to whether the requested secret is cached locally, as shown at 818. If the determination is that the secret is indeed stored locally, the secret can then be sent to the legacy application, as shown at 814. Otherwise, if no secret is found locally, the user can be prompted to enter the secret directly in the legacy application login form.

In addition to the advantageous mapping features described above, an implementation of an identity selector in accordance with the disclosed technology can also determine the identity of the application or process that is requesting the identity information and inform the user of the identity. This can desirably provide a user with the ability to essentially fingerprint the application so that the user will be able to understand what application or process is requesting the information. The user can then choose to either “Allow” or “Deny” any release of the requested information. In such a scenario, the identity selector is effectively acting as a proxy in requesting the information, as the information will eventually be passed to an application that, in turn, will likely use it to authenticate to a service on the local network or Internet.

Embodiments of the disclosed technology can include a protocol for the user to update information stored at the identity provider. Specifically, this can allow the user certain information (e.g., identity provider managed information, subject to identity provider policy restrictions) directly from within the identity selector. This can provide the user with the ability to push secrets (e.g., secrets that are encrypted using keys available in the card store) to the identity provider, thereby allowing the identity provider to act as a distributed secret store provider.

In certain embodiments, a token service (e.g., run by an identity provider) can restrict the release of credentials based on information about the end recipient of the credentials passed by the identity selector in the “Applies To” section of the request for the security token (RST). The token service can also provide an audit log of credential disclosures (e.g., for compliance purposes).

In certain implementations of the disclosed technology, in which a user visits a website that presents the user with a user login form (e.g., in order to access a user email account), a CASA engine can be enabled to perform a form-fill operation on the page (e.g., by populating the requested fields with information returned in a token based on an information card).

Among the various advantageous features of the disclosed technology can include, for example, an ability to map credentials such as SSO keys/passwords, for example, to virtually any claim provided by an information card, an ability to use an identity selector as a proxy in order to provide credentials to a non-web-based application, and use of information cards as a secret store provider to services such as CASA, GNOME Keyring, etc.

The following discussion is intended to provide a brief, general description of a suitable machine in which embodiments of the disclosed technology can be implemented. As used herein, the term “machine” is intended to broadly encompass a single machine or a system of communicatively coupled machines or devices operating together. Exemplary machines can include computing devices such as personal computers, workstations, servers, portable computers, handheld devices, tablet devices, and the like.

Typically, a machine includes a system bus to which processors, memory (e.g., random access memory (RAM), read-only memory (ROM), and other state-preserving medium), storage devices, a video interface, and input/output interface ports can be attached. The machine can also include embedded controllers such as programmable or non-programmable logic devices or arrays, Application Specific Integrated Circuits, embedded computers, smart cards, and the like. The machine can be controlled, at least in part, by input from conventional input devices (e.g., keyboards and mice), as well as by directives received from another machine, interaction with a virtual reality (VR) environment, biometric feedback, or other input signal.

The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology can be described by reference to or in conjunction with associated data including functions, procedures, data structures, application programs, instructions, etc. that, when accessed by a machine, can result in the machine performing tasks or defining abstract data types or low-level hardware contexts. Associated data can be stored in, for example, volatile and/or non-volatile memory (e.g., RAM and ROM) or in other storage devices and their associated storage media, which can include hard-drives, floppy-disks, optical storage, tapes, flash memory, memory sticks, digital video disks, biological storage, and other tangible, physical storage media.

Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. An apparatus, comprising:
a machine;
a secret mapping module running on the machine and configured to create a mapping that maps a secret to a claim stored in an information card;
a receiver running on the machine and configured to receive a request for the secret from a remote application;
a mapping query module running on the machine and configured to perform a search for the mapping;
a credential provider application running on the machine and configured to retrieve the secret based at least in part on the claim; and
a transmitter configured to transmit the secret to the remote application.

2. The apparatus of claim 1, wherein the remote application comprises a legacy application running on the machine.

3. The apparatus of claim 1, further comprising an information card selector configured to prompt a user to select the information card.

4. The apparatus of claim 1, wherein the secret comprises a credential.

5. The apparatus of claim 4, wherein the credential comprises a username and a password.

6. The apparatus of claim 1, wherein the claim comprises a claim type and a claim identifier.

7. The apparatus of claim 6, wherein the claim identifier comprises a Uniform Resource Identifier (URI).

8. The apparatus of claim 1, further comprising a secret store provider running on the machine and configured to query a secret store for the secret.

9. A computer-implemented method, comprising:
receiving a request from a relying party for a credential;
querying a plurality of information cards for a claim, wherein the credential is mapped to the claim;
responsive to finding an information card comprising the claim, selecting the information card;
based at least in part on the claim, retrieving the credential; and
transmitting the credential to the relying party.

10. The computer-implemented method of claim 9, wherein the relying party comprises a legacy application.

11. The computer-implemented method of claim 9, wherein the credential comprises a single sign-on (SSO) key.

12. The computer-implemented method of claim 9, wherein the credential comprises a usemrname and a password.

13. The computer-implemented method of claim 9, further comprising, responsive to not finding an information card comprising the claim, directly prompting a user for the credential.

14. The computer-implemented method of claim 9, further comprising, responsive to not finding an information card comprising the claim, querying a secret store for the credential.

15. The computer-implemented method of claim 14, further comprising, responsive to not finding the credential in the secret store, directly prompting a user for the credential.

16. The computer-implemented method of claim 14, further comprising, responsive to finding the credential in the secret store, transmitting the credential to the relying party.

17. The computer-implemented method of claim 9, further comprising invoking a card selector to prompt a user to select the information card comprising the claim.

18. A tangible computer-readable medium storing instructions that, when executed by a processor, result in:
receiving a request from a relying party for a username and a password;
performing a search for an information card comprising a first claim and a second claim, wherein the username is mapped to the first claim and the password is mapped to the second claim;
based at least in part on the first and second claims, retrieving the requested username and password; and
transmitting the retrieved username and password to the relying party.

19. The tangible computer-readable medium of claim 18, wherein retrieving the requested username and password comprises retrieving a token from an identity provider and using the first and second claims to decode the token.

20. The tangible computer-readable medium of claim 18, having stored thereon further instructions that, when executed by the machine, result in:
responsive to not finding the information card, searching a secret store for the requested username and password; and
transmitting the requested username and password to the relying party.
